(19) United States
(12) Patent Application Publication
(10) Pub. No.: US 2010/0031953 A1
(43) Pub. Date: Feb. 11, 2010

(54) Hybrid Water Heating System

(76) Inventors: Krassimire Mihaylov Penev, Stamford, CT (US); Gordon Patrick Whelan, Stamford, CT (US)

Correspondence Address: GORDON & JACOBSON, P.C., 60 LONG RIDGE ROAD, SUITE 407, STAMFORD, CT, 06902, US

(21) Appl. No.: 12/205,979

(22) Filed: Sep. 8, 2008

Related U.S. Application Data
(60) Provisional application No. 61/086,819, filed on Aug. 7, 2008.

(51) Int. Cl. F24J 2/42; F24J 2/04; F24H 3/02; G05D 23/00; F24J 3/08

(52) U.S. Cl. 126/615; 126/646; 165/121; 165/279; 165/45

(57) ABSTRACT

A water heating system for controlling the heating of potable water in commercial or private dwellings with improved energy efficiency. The water heating system heats potable water in a tank by transferring excess heat generated in a refrigeration unit with a heat exchanger, and by extracting energy from insolation with a solar water heater unit. The system includes several control systems for regulating the operation of the heat exchanger, solar water heater unit, and refrigeration unit to provide increased energy efficiency and longevity to the various components of the system.

### CROSS-REFERENCE TO RELATED APPLICATIONS

This application claims benefits from U.S. Provisional Patent Application No. 61/086,819, filed on Aug. 7, 2008, the contents of which are hereby incorporated herein by reference.

### BACKGROUND OF THE INVENTION

1. Field of the Invention

The present invention is related to heating systems for potable water. More particularly, the present invention is related to water heating systems having a solar water heater unit, a heat recovery unit, and, if necessary, a conventional heating element.

2. State of the Art

Commercial and residential facilities and dwellings include various systems for heating potable water. Commonly, these water heating systems include a tank with a heating element that is configured to increase the temperature of water within the tank. The heating element can be an electrically powered element, a gas-burning element, an oil-burning element, or combinations of these elements. Unfortunately, the cost of fuel sources used by such conventional heating elements can reduce the economic feasibility of such water heating systems.

Hot water heating systems that reduce the usage of such fuel sources may thus provide increased economic feasibility.

### SUMMARY OF THE INVENTION

A water heating system is provided for controlling the heating of potable water in commercial or private dwellings with improved energy efficiency. The water heating system includes a tank that stores potable water in fluid communication with a potable water source, a refrigeration unit that circulates refrigerant for air conditioning or other refrigeration purposes, a heat recovery unit (HRU) that transfers heat from the circulating refrigerant of the refrigeration unit to the water stored in the tank, and a solar water heater unit that extracts heat from insolation and transfers the extracted heat to the water stored in the tank.

The refrigeration unit preferably includes a first fluid loop for circulating the refrigerant, a compressor coupled to the first fluid loop for compressing the refrigerant, a fan and an expansion valve coupled to the first fluid loop for cooling the refrigerant, and an evaporator section along the first fluid loop which absorbs heat from a refrigeration area to cool the refrigeration area.

The heat recovery unit includes a first heat exchanger and a second fluid loop which circulates a first heat transfer medium between the tank and the first heat exchanger. The first heat exchanger has a first flow path which is part of the first fluid loop of the refrigeration unit, and a second flow path which is part of the second fluid loop and thermally coupled to the first flow path. Thus, the second fluid loop of the heat recovery unit is thermally coupled to the first fluid loop of the refrigeration unit at the heat exchanger, which allows the first heat transfer medium circulating in the second fluid loop to transfer heat from the refrigerant to the water stored in the tank. In the exemplary embodiment, the second fluid loop is in direct fluid communication with the water stored in the tank such that first heat transfer medium circulating through the second fluid loop is water from the tank.

The solar water heater unit includes a solar collector which extracts energy from insolation, and a third fluid loop which circulates a second heat transfer medium between the solar collector and the tank to heat the potable water in the tank.

The refrigeration unit, heat recovery unit, and solar water heater unit each include measuring means for measuring temperature, pressure, or other parameters at various locations in the system, and control means for controlling their operation based on the measured parameters to maximize the energy efficiency, hot water capacity, and longevity of the system while reducing the system's operational costs and fuel consumption.

The refrigeration unit preferably includes a fan control means which operates to deactivate (turn off) the cooling fan of the refrigeration unit when the refrigerant is sufficiently cooled on account of the operation of the heat exchanger in transferring heat away from the refrigerant to the water in the tank, and operates to activate (turn on) the cooling fan of the refrigeration unit when additional cooling is needed.

The heat recovery unit preferably includes HRU control means which operates to activate the heat recovery unit to circulate the first heat transfer medium in the second fluid loop when (1) the temperature of the water in the second fluid loop becomes so low that it is in danger of freezing; and (2) when the refrigerant between the compressor and the heat exchanger is above a predetermined temperature (e.g., 125° Fahrenheit) and the potable water in the tank is below a maximum tank temperature (e.g., 155° Fahrenheit). During normal operation, the temperature of the refrigerant between the compressor and the heat exchanger will generally be higher than the temperature of the water in the tank, and the water temperature in the tank will generally be below the maximum temperature desired. Thus, the heat exchanger operates to transfer energy from the refrigerant (which would otherwise need to be expelled to the atmosphere through the use of the fan) to the water in the tank, thereby reducing the fan's operation requirements.

The solar water heater unit preferably includes solar control means which operates to activate the solar water heater unit to circulate the second heat transfer medium in the third fluid loop when two conditions are met: (1) the difference between the temperature of the second heat transfer medium at the solar collector exceeds the temperature of the potable water in the tank by a predetermined amount (e.g., 8-24° Fahrenheit); and (2) the temperature of the potable water in the tank is below the maximum tank temperature desired (e.g., below a maximum tank temperature that is within a range of 155-200° Fahrenheit). The first condition allows for the activation of the solar water heater unit when efficient heat transfer can take place. The second condition prevents the water in the tank from exceeding a maximum temperature. A relief valve is provided to allow for the removal of a portion of the second heat transferring medium from the third fluid loop in the event that the second heat transferring medium gets too hot at the solar collector.

In other embodiments, an additional tank is utilized for storing the potable water. The additional tank is in fluid communication with both the tank (which operates as a preheater tank) and the potable water source, and bypass valves are provided which may be set to enable the potable water to bypass the tank and flow directly into the additional tank.

Additional objects, advantages, and embodiments of the invention will become apparent to those skilled in the art upon reference to the detailed description taken in conjunction with the provided figures.

### BRIEF DESCRIPTION OF THE DRAWINGS

FIG. 1 is a schematic depiction of an exemplary embodiment of a hybrid water heating system according to the present invention.

FIG. 2 is a schematic depiction of another exemplary embodiment of a hybrid water heating system according to the present invention.

FIG. 3 is a table describing the function of the fan control means of the refrigeration unit of the invention.

FIG. 4 is a table describing the function of the HRU control means of the heat recovery unit of the invention.

FIG. 5 is a table describing the function of the solar control means of the solar water heater unit of the invention.

FIG. 6 is a schematic of the circuitry of an embodiment of the controller of the heat recovery unit of the invention.

FIG. 7 is a schematic of the circuitry of an embodiment of the operational control of the fan of the invention.

### DETAILED DESCRIPTION

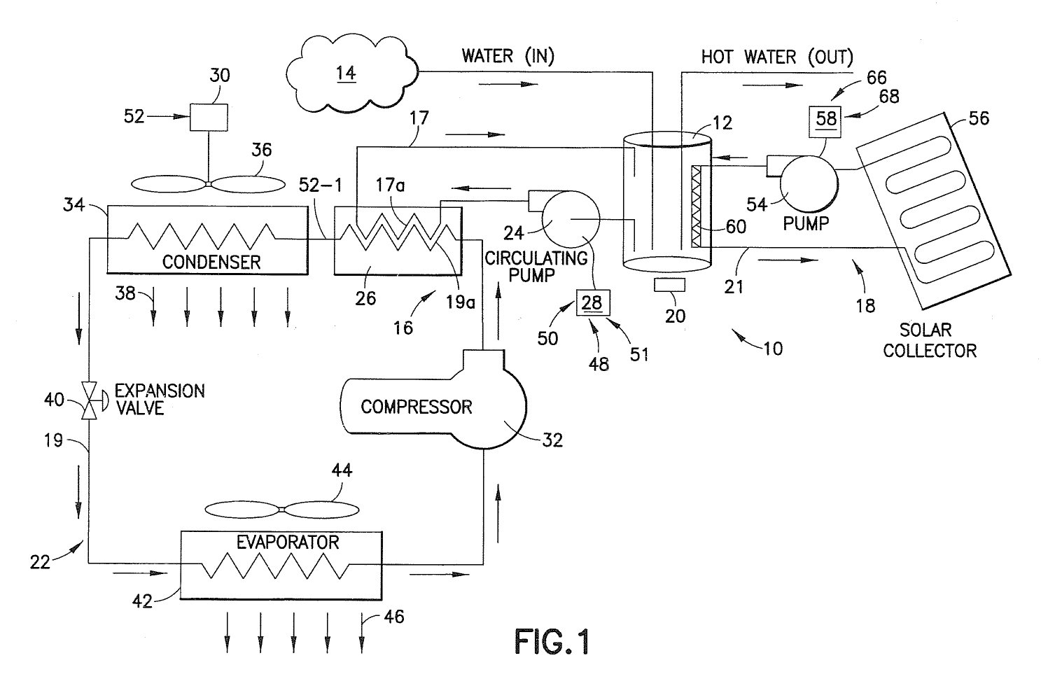

Turning now to FIG. 1, a water heating system according to the present disclosure is shown and is generally referred to by reference numeral 10. The system 10 includes a tank 12 in fluid communication with a source 14 of potable water such as, but not limited to, a well or a city water source. The tank 12 is configured to place water stored therein in a heat exchange relationship with a heat recovery unit 16, a solar water heater unit 18, and a heating element 20. The system 10 is configured to heat the potable water in the tank 12 by using heat available from free sources (e.g., refrigeration and solar units) in conjunction with the conventional heating element 20 to provide an energy efficient hot water heating system.

The heat recovery unit 16 of the system 10 is in a heat exchange relationship with a conventional vapor compression refrigeration unit 22 such as, but not limited to, an air conditioner, a refrigerator, a freezer, a heat pump, or equivalent refrigeration units known in the art. The heat recovery unit 16 includes a first circulating pump 24 which circulates water from the tank 12 through a flow loop 17, a heat exchanger 26, and a first controller 28. When heat is available from the vapor compression refrigeration unit 22, the first controller 28 is configured to activate the pump 24 to pump the water from the tank 12 through the heat exchanger 26 and back into the tank 12.

The refrigeration unit 22 includes a flow loop 19 for circulating refrigerant. A compressor 32 operably coupled to the flow loop 19 compresses the refrigerant and passes the compressed refrigerant to a condenser 34. The condenser 34 is also operably coupled to the flow loop 19 and includes a cooling fan 36 to force outside air 38 across the condenser 34 to remove heat from the refrigerant within the flow loop 19. Thus, the refrigeration unit 22 typically consumes electrical energy to operate the cooling fan 36 to expel waste heat to the outside air 38. The compressed, condensed refrigerant is then expanded in an expansion valve 40 to a lower temperature, and then passed through an evaporator 42. The evaporator 42 includes a blower unit 44 which blows inside air 46 from a conditioned space across the evaporator 42. The refrigeration unit 22 thus provides conditioned air 46 to a conditioned space.

The heat exchanger 26 of the heat recovery unit 16 is in heat exchange communication with the refrigerant in the flow loop 19 between the compressor 32 and the condenser 34, which is generally at a high temperature. The heat exchanger 26 operates to transfer waste heat (which is typically removed from the refrigerant by the fan 36 in the prior art) to the water in tank 12, which will generally be at a lower temperature than that of the refrigerant between the compressor 32 and the condenser 34. The heat exchanger 26 includes a first flow path 19a which is part of the flow loop 19 of the refrigeration unit 16, and a second flow path 17a which is part of the flow loop 17 of the heat recovery unit 16 and thermally coupled to the first flow path 19a. The heat recovery unit 16 removes heat from the refrigerant in the flow loop 19 of the refrigeration unit 22 and transfers it to the potable water in the tank 12, which also reduces the typical cooling requirements of the fan 36.

The operation of the controller 28 of the heat recovery unit 16 of the system 10 is best understood with reference to FIGS. 1, 4, and 6. The controller (HRU control means) 28 activates the circulation pump 24 to circulate water from the tank 12 through the heat exchanger 26 when heat is available from the refrigeration unit 22. For example, the controller 28 can receive a first input 48 indicative of a condition of the refrigerant in the refrigeration unit 22 such as, but not limited to, a temperature signal, a pressure signal, or other signals conveying information related to the refrigerant's properties. When the first input 48 reaches a predetermined level indicating that heat is available from the refrigeration unit 22, the controller 28 may activate the circulation pump 24. In one example, the first input 48 can be a temperature signal and the predetermined level might be 125 degrees Fahrenheit (F).

The controller 28 is also preferably configured to deactivate the circulating pump 24 to cease circulating water from the tank 12 through the heat exchanger 26 when the water within the tank 12 reaches a predetermined temperature. For example, the controller 28 may receive a second input 50 indicative of the water temperature within the tank 12. When the second input 50 reaches a predetermined level, the controller 28 deactivates the circulation pump 24. In one example, the second input 50 may be a temperature signal and the predetermined level might be 155 degrees Fahrenheit (F).

The controller 28 may also be configured to activate the circulating pump 24 when the temperature of the water in the second fluid loop 17 becomes so low that it is in danger of freezing. For example, the controller 28 may receive a third input 51 indicative of the water temperature within the second fluid loop 17. When the third input 51 reaches a predetermined level, the controller 28 activates the circulation pump 24 to circulate water from the tank 12 through the second fluid loop 17 to prevent freezing therein. It is noted that if the refrigeration unit 22 is operational, then the circulating pump 24 will operate as discussed above to transfer heat from the refrigerant to the water at the heat exchanger 26. But in the event that the refrigeration unit 22 goes down during the winter months, the operation of the circulating pump 24 to circulate water from the tank 12 through the second fluid loop 17 will help to prevent the water from freezing in the second fluid loop 17. It is anticipated that other back-up sources of heat may be utilized with the system (such as gas or oil) to heat the tank 12 so that the tank 12 water will remain warm even during a long power outage. It is also anticipated that this anti-freezing operation of the controller 28 will be far less common, but will provide an important safety measure in the winter time to prevent the heat recovery unit 16 from freezing and increase its longevity.

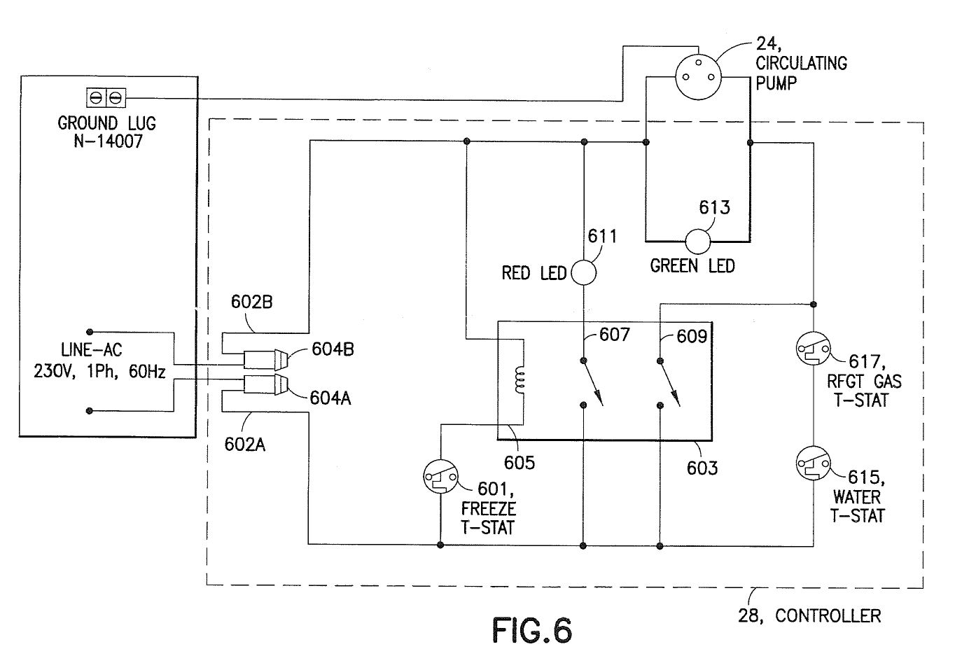

The controller 28 can be embodied by a variety of control circuitry, such as a programmed controller or dedicated hardware logic (PLD, FPGA, ASIC) and supporting circuitry (e.g., thermistors for temperature sensing or pressure transducers for pressure sensing), one or more relays and supporting circuitry (e.g., thermostats for temperature sensing or pressure controllers for pressure sensing) or other suitable circuitry. An exemplary embodiment of controller 28 is illustrated in FIG. 6, which includes a first thermostat 601 coupled between one leg 602A of line AC and the control path 605 of a double pole single throw relay 603 that extends to the other leg 602B of line AC. The legs 602A, 602B of line AC are protected by corresponding fuses 604A, 604B, respectively. The relay 603 includes two switchable current paths 607, 609 that are selectively activated by the electrical signals of the control path 605. The current path 607 extends to a red LED 611 series coupled between the relay 603 and leg 602B of line AC. The current path 609 is connected to a green LED 613 coupled between the relay 603 and leg 602B of line AC. Second and third thermostats 615, 617 are series coupled between leg 602A of line AC and the green LED 613. Like the green LED, one of the terminals of the circulating pump 24 is connected to leg 602B of line AC while the other terminal is connected to the current path 609 from the relay 603 as well as the current path through the series coupled thermostats 615, 617.

The first thermostat 601 is configured to sense tank water temperature and provide a normally-off current path that is turned on when the temperature of the tank water or water within the second fluid loop 17 falls below a threshold temperature (e.g., 38° F.) that indicates that the heat recovery unit 16 is near freeze up. When the first thermostat 601 is on, current flows through the control path 605 of the relay 603 and turns ON the switchable current paths 607 and 609 through the relay 603. Such operations produce current flowing between the two legs 602A, 602B of line AC that turns on the red LED 611 as well as turns on the green LED 613 and the circulating pump 24 for heating the water to prevent such freeze up in the heat recovery unit 16. The current path of the first thermostat 601 is returned to the normally-off state when the temperature exceeds a predetermined temperature (e.g., 48° F.). In the normally-off state of the first thermostat 601, there is no current flowing through the control path 605 of the relay 603 and thus the switchable current paths 607, 609 through the relay 603 are off, which dictate that the red LED 611 is turned OFF and allow for control of the circulating pump 24 by the second and third thermostats 615, 617.

The second thermostat 615 is configured to sense temperature of the water in the tank 12 and provide a normally-on current path that is turned off when the temperature of the tank water reaches a predetermined temperature (e.g., 155° F.). The third thermostat 617 is configured to sense temperature of the refrigerant of the fluid loop 19 and provide a normally-off current path that is turned on when the temperature of the refrigerant reaches a predetermined temperature (e.g., 125° F.). In this manner, two thermostats 615 and 617 provide current that flows from leg 602A to the green LED 613 and the circulating pump 24 to activate both the green LED 613 and the circulating pump 24 when the temperature of the tank water is less than the predetermined temperature (e.g., 155° F.) and the temperature of refrigerant of fluid loop 19 is greater than the predetermined temperature (e.g., 125° F.). In the off state of the second or third thermostats 615, 617, there is no current flowing through the thermostats 615, 617 to the green LED 613 and the circulating pump 24, which allows for control of the circulating pump by the first thermostat 601 and relay 603 as described above.

It is noted that in other embodiments, the controller 28 may be configured to activate the circulating pump 24 to use the water from the tank 12 to heat the refrigerant regardless of the water temperature in the tank 12 in the event that the temperature of the refrigerant in the flow loop 19 becomes low enough to potentially hinder the operation of the refrigeration unit 16 (e.g., input 48 may override input 50 in the event that the refrigeration unit 16 is in danger of freezing up).

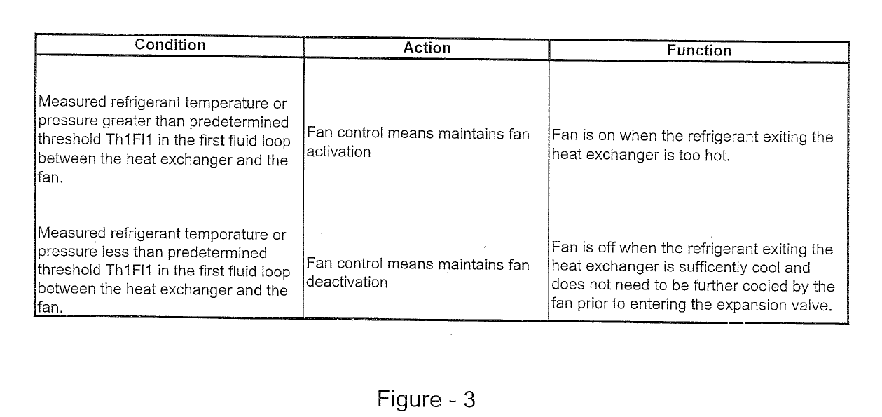

The operational control of the fan 36 of the refrigeration unit 16, is best understood with reference to FIGS. 1, 3, and 7. A fan control 30 is provided in the form of a delay relay or controller in electrical communication with the fan 36. During normal operation of the refrigeration unit 16, the fan control 30 delays the operation of the fan 36 until a condition within the refrigeration unit 16 reaches a predetermined level. As discussed above, the heat recovery unit 16 removes heat from the refrigerant in the flow path 19a of the flow loop 19 of the refrigeration unit 22 that would otherwise need to be removed by the fan 36. Thus, the fan 36 need not be operated until the heat recovery unit 16 can no longer remove enough heat from the refrigeration unit 22 to keep the refrigeration unit 16 operating in a desired manner.

For example, in medium temperature refrigeration units such as those present in a restaurant, bar, or other commercial establishment, it is typically desired that the refrigerant exiting the condenser 34 be in a vapor condition with a desired temperature and/or pressure. The fan control 30 receives a fourth input 52 from the refrigeration unit 22 which is indicative of the temperature of refrigerant within the flow loop 19 of the refrigeration unit 16. The fan control 30 maintains the fan 36 in an off condition until the fourth input 52 reaches a predetermined level, at which time, the fan control 30 activates the fan 36 to expel heat from the refrigerant to the ambient air 38 at the condenser 34.

In one preferred embodiment, the fourth input 52 is a pressure input from a pressure transducer 52-1 positioned in the flow loop 19 of the refrigeration unit 22 between the heat exchanger 26 and the condenser 34. If the pressure of the refrigerant in the flow loop 19 exceeds a predetermined limit after passing through the heat exchanger 26, then insufficient heat has been removed from the refrigerant by the heat exchanger 26. Typically, this results from the water in the tank 12 being of a sufficiently high temperature from the heat already collected by the heat recovery unit 16 and/or the solar collection unit 18 (further discussed below).

When the pressure of the refrigerant in the flow loop 19 exceeds a predetermined limit after passing through heat exchanger 26, the fan control 30 activates the cooling fan 36 to expel waste heat from the refrigerant to the outside air 38. Conversely, when the pressure of the refrigerant in the flow loop 19 is below the predetermined limit after passing through heat exchanger 26, the fan control 30 maintains the cooling fan 36 in a normally deactivated state. In embodiments of the invention in which the refrigeration unit 22 is a medium temperature refrigeration unit, the predetermined pressure limit at transducer 52-1 could be approximately 200 pounds per square inch (PSI).

The controller 30 can be embodied by a variety of control circuitry, such as a programmed controller or dedicated hardware logic (PLD, FPGA, ASIC) and supporting circuitry (e.g., thermistors for temperature sensing or pressure transducers for pressure sensing), one or more relays and supporting circuitry (e.g., thermostats for temperature sensing or pressure controllers for pressure sensing) or other suitable circuitry. An exemplary embodiment of controller 30 is shown in FIG. 7, which includes a pressure control unit 701 electrically coupled between one leg 702A of line AC and one of the terminals of the condenser fan 36 as shown. The other terminal of the condenser fan is connected to the other leg 702B of line AC. A capillary tube 703 is fluidly coupled to the fluid loop 19, preferably at a point downstream of the heat recovery unit 26 and upstream of the condenser 34 (e.g., preferably at 52-1 as shown, but may optionally be placed anywhere along the length of the condenser) in order to sample the pressure of the refrigerant in the fluid loop 19. The pressure control unit 701 measures the sampled pressure of the refrigerant of the fluid loop 19 and provides a normally-off current path between leg 702A and the terminal of the condenser fan 36 that is turned on when the sampled pressure reaches a predetermined cut-in pressure. This current path is then returned to the normally-off state when the pressure falls below a predetermined cut-off pressure. In the preferred embodiment, the cut-in and cut-out pressures are set by user input (for example, by user adjustment of dials for setting such cut-in and cut-out pressures). In the preferred embodiment, the pressure control unit 701 is realized by a unit (e.g., the 016 Single Pressure Control unit) sold commercially by Ranco Controls of Delaware, Ohio.

Thus, system 10, through the operation of the fan control 30 of the refrigeration unit 22, maximizes the amount of heat recovered by the heat recovery unit 16 by eliminating the expulsion of heat from the refrigerant to the ambient air when such expulsion not needed. Further, system 10 minimizes energy usage by leaving fan 36 in a normally “off” state until such time as the heat recovery unit 16 no longer has sufficient capacity to remove enough heat from the refrigerant in the flow loop 19 to keep the refrigeration unit 22 operating as desired.

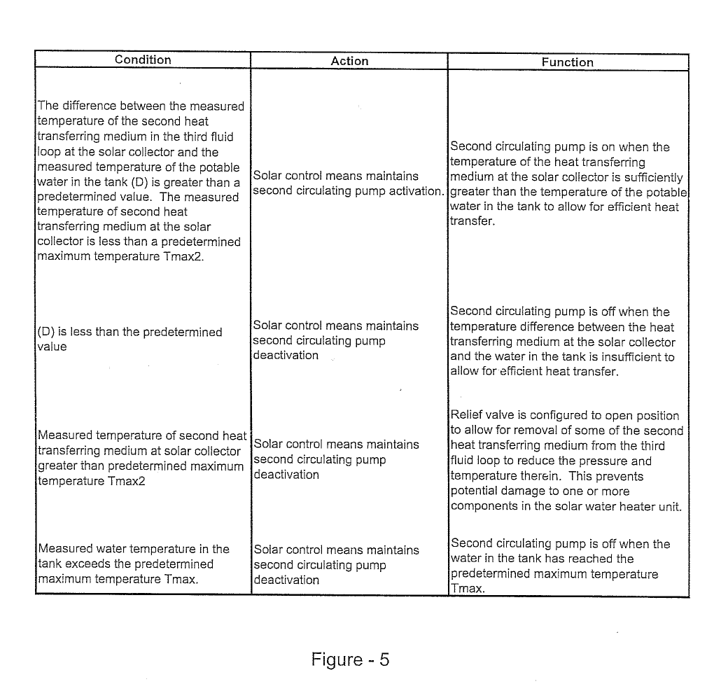

The system 10 of the present invention also preferably incorporates the solar water heater unit 18 and uses it in conjunction with the heat recovery unit 16. The solar water heater unit 18 and its operational control is best understood with reference to FIGS. 1 and 5.

The solar collection unit 18 provides heat captured from solar energy to the water in the tank 12. Thus, the water in tank 12 is heated not only by the heat recovery unit 16, but also by the solar collection unit 18. As such, the ability of the water in tank 12 to remove sufficient heat from the refrigeration unit 22 can be reduced when the solar collection unit 18 is operating. The fan control 30 protects the refrigeration unit 22 from damage due to overheating and maintains the refrigeration unit 22 in a desired operating condition when a large amount of heat is added to the water in the tank 12 by both the heat recovery unit 16 and solar collection unit 18.

The solar collection unit 18 includes a second circulating pump 54 which circulates a second heat transfer medium through a flow loop 21. A solar collector 56 and second heat exchanger 60 are operably coupled to the flow loop 21 as shown in FIG. 1. A second controller 58 is provided for selectively activating and deactivating the second circulating pump 54 of the solar collection unit 18. When heat is available from solar energy, the second controller 58 is configured to activate the circulating pump 54 to pump a heat-transfer fluid such as, but not limited to, propylene glycol through the solar collector 56 and the heat exchanger 60 via the fluid loop 21. The solar collector 56 thus heats the heat-transfer fluid, and the heat from the heat-transfer fluid is used to indirectly heat the water in the tank 12 via the heat exchanger 60.

The fluid loop 21 of the solar collection unit 18 is shown by way of example as an indirect or closed-loop circulation system where the circulating pump 54 circulates the heat-transfer fluid through the solar collector 56 and the heat exchanger 60 to indirectly heat the water in the tank 12. However, the solar collection unit 18 may also be a direct or open-loop circulation system in which the pump 54 circulates the potable water from the tank 12 directly through the solar collector 56 and back into the tank 12.

Conversely, while the fluid loop 17 of the heat recovery unit 16 is shown by way of example as a direct or open-loop circulation system where the pump 24 circulates the water from the tank 12 through the heat exchanger 26 and back into the tank 12, the fluid loop 17 may instead be an indirect or closed-loop circulation system fluidly isolated from the water in the tank 12 in which the pump 24 circulates a heat-transfer fluid through the heat exchanger 26 and through an additional heat exchanger (not shown) in a heat exchange relationship with the water in tank 12 to indirectly heat the water in the tank.

In addition, the heat exchanger 60 disposed at the tank 12 is shown by way of example only as a flat heat exchanger in tank 12. However, it is contemplated that the heat exchanger 60 may be any device sufficient to place the heat-transfer fluid of the solar collection unit 18 in a heat exchange relationship with the water in the tank 12. The tank 12 may also be a jacketed tank in which the heat exchanger 60 forms a heat exchange jacket around the outer surface of the tank 12.

The solar collector 56 can be any device sufficient to collect heat from solar energy. For example, the solar collector 56 can be a glazed flat-plate collector, an un-glazed flat-plate collector, an evacuated-tube solar collector, a photo-voltaic module, a drain-back system, and any combinations thereof.

The term “glazed flat-plate collectors” used herein refers to collectors having an insulated, weatherproofed box that contains a dark absorber plate under one or more glass or plastic covers. The term “unglazed fiat-plate collectors” used herein refers to collectors having a dark absorber plate, made of metal or polymer, without a cover or enclosure. The term “evacuated-tube solar collectors” used herein refers to collectors having parallel rows of transparent glass tubes where each tube contains a glass outer tube and a metal absorber tube attached to a fin. The fin's coating absorbs solar energy but inhibits radiative heat loss. The term “photo-voltaic module” used herein refers to collectors having an array of photo-voltaic cells that convert solar energy into electrical potential. The electrical potential can be used to provide current to an electrical heating element, which heats the water in the tank 12.

The controller 58 of the solar water heater unit 18 controls the circulating pump 54 to circulate the heat-transfer fluid from the heat exchanger 60 in the tank 12 through the solar collector 56 only when heat is available at the solar collector 56. For example, the controller 58 may receive a fifth input 66 indicative of a condition of the solar collector 56. The fifth input 66 may include, but is not limited to, a temperature signal indicative of the temperature of the heat-transfer fluid at the solar collector 56. When the fifth input 66 reaches a predetermined limit indicating that sufficient heat is available from the solar collector 56, the controller 58 activates the circulation pump 54.

The controller 58 is preferably configured to deactivate the circulating pump 54 to cease circulating the heat-transfer fluid through the solar collector 56 and the heat exchanger 60 when the water within the tank 12 reaches a predetermined temperature. For example, the controller 58 can receive a sixth input 68 indicative of a temperature of the water within the tank 12. When the sixth input 68 reaches a predetermined limit, the controller 58 deactivates the circulating pump 54. The circulating pump 54 can be an electrically powered pump, powered by a standard 115-volt power source. The pump 54 may also be powered by electricity collected by a photo-voltaic solar collector (not shown).

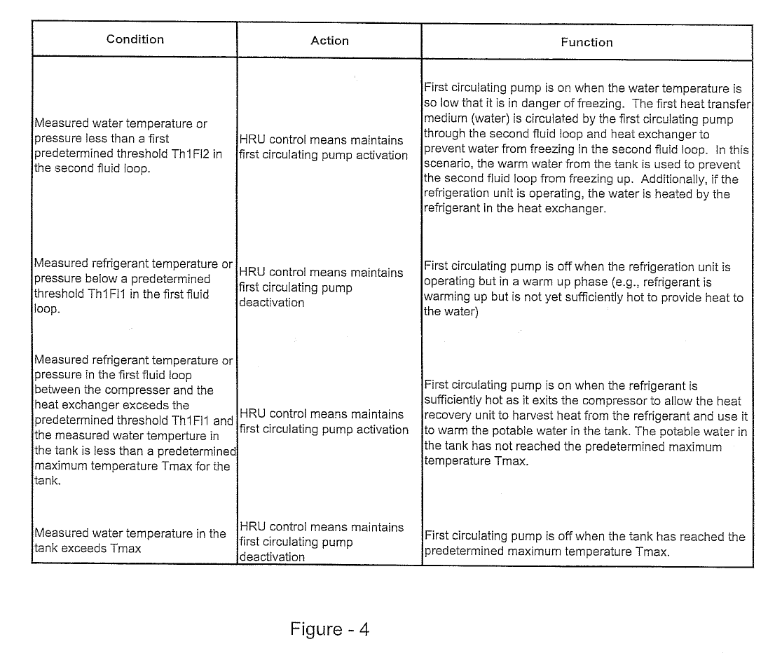

The controller 58 is described by way of example as operating based on a first temperature limit (e.g., sensed from fifth input 66) and a second temperature limit (e.g., sensed from sixth input 68). However, as discussed in FIG. 5, the controller 58 may also operate as a differential controller in which the controller 58 activates the circulating pump 54 when the fifth and sixth inputs 66, 68 are indicative of a temperature differential of at least a predetermined value. For example, the controller 58 can be configured to activate the circulating pump 54 when the fifth and sixth inputs 66, 68 are indicative of at least approximately 8 degrees Fahrenheit (F) and can deactivate the pump when the temperature differential is less than approximately 8 degrees Fahrenheit (F). Similarly, the controller 28 of the heat recovery unit 16 (FIGS. 1 and 4) may be configured to operate as a differential controller in which the controller 28 only activates the circulating pump 24 when the first and second inputs 48, 50 are indicative of at least a predetermined value. The controller 58 can also operate to deactivate the circulating pump 54 upon the fifth input 66 exceeding a third temperature limit indicative that the solar collector is at a maximum temperature for preventing damage to system components. A relief valve (not shown) is operably coupled to the flow loop 21 for lowering the pressure within the flow loop 21 in the event that the fifth input 66 exceeds the third temperature limit. In an open configuration of the relief valve, the second heat transferring medium is drained from the flow loop 21 in gas or liquid form to lower the pressure therein.

The controller 58 can be embodied by a variety of control circuitry, such as a programmed controller or dedicated hardware logic (PLD, FPGA, ASIC) and supporting circuitry (e.g., thermistors for temperature sensing or pressure transducers for pressure sensing), one or more relays and supporting circuitry (e.g., thermostats for temperature sensing or pressure controllers for pressure sensing) or other suitable circuitry. In an exemplary embodiment, the controller 58 is realized by a programmed controller adapted for differential temperature control of solar energy systems, such as the GL-30 module sold commercially by Goldline Controls Inc of East Greenwich, R.I.

When heat is unavailable from either the heat recovery unit 16 or the solar collection unit 18, the system 10 utilizes a conventional heating element 20 to heat the water in the tank 12. Heating element 20 may be an electrically powered element, a gas-burning element, an oil-burning element, and combinations thereof.

The hybrid hot water heat system 10 of the present invention thus combines three heating sources, two of which are available without consuming additional energy. Additionally, the fan control 30 of the hybrid hot water heat system 10 of the present invention selectively activates and deactivates the fan 36 of the vapor compression refrigeration unit 22 to minimize the available heat expelled to the ambient air 38. The fan control 30 also maximizes the amount of heat recovered by the heat recovery unit 16 and minimizes the amount of energy used while protecting the vapor compression refrigeration unit 22 from being damaged.

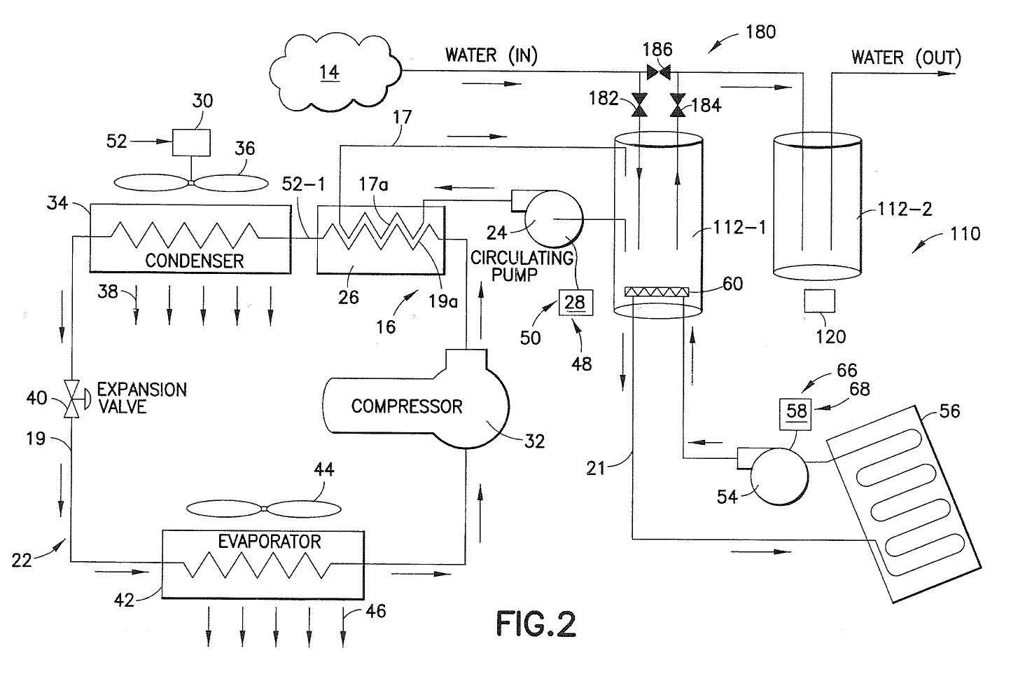

An additional preferred embodiment of the hybrid hot water heating system 10 according to the present invention is shown in FIG. 2 and is generally referred to by reference numeral 110. System 110 is substantially similar to system 10, and, for clarity, only those components that differ from system 10 are described below.

System 110 is a two-tank system that includes a pre-heat tank 112-1, a conventional heating tank 112-2, and a bypass system 180. The pre-heat tank 112-1 is in a heat exchange relationship with the heat recovery unit 16 and the solar collection unit 18 in the manner described above with respect to system 10. The heating tank 112-2 includes a conventional heating element 120, which may be an electrically powered element, a gas-burning element, an oil-burning element, and combinations thereof. The combination of the pre-heat tank 112-1 with the heating tank 112-2 allows the system 110 to maximize the collection and storage of heat from the heat recovery unit 16 and the solar collection unit 18.

The bypass system 180 allows a user to divert incoming water from the water source 14 to bypass the pre-heating tank 112-1 to flow directly into the heating tank 112-2. In the illustrated embodiment of FIG. 2, the bypass system 180 includes a first valve 182, a second valve 184, and a third valve 186, each being a two-way valve having an open state and a closed state. When an operator desires the use of the pre-heating tank 112-1, the first and second valves 182, 184 can be moved to the open state while the third valve 186 is moved to the closed state. In this configuration, water from the water source 14 flows through the first valve 182 into the pre-heat tank 112-1 and from the pre-heat tank 112-1 to the heating tank 112-2 through the second valve 184.

Conversely, when an operator desires to bypass pre-heating tank 112-1, the first and second valves 182, 184 can be moved to the closed state while the third valve 186 is moved to the open state. In this configuration, water from the water source 14 flows through the third valve 186 directly into the heating tank 112-2 without passing through pre-heating tank 112-2.

The bypass system 180 is described above by way of example as a manually activated system in which the operator moves the valves 182, 184, 186 between the open and closed states. However, it is contemplated that the valves of bypass system 180 may be automatically controlled between the open and closed states based on the availability of heat from either the heat recovery unit 16 or the solar collection unit 18.

Additionally, the bypass system 180 is described above by way of example with respect to the three separate two-way valves 182, 184, and 186. However, it is contemplated that the bypass system 180 may include any combination of valves sufficient to selectively place the pre-heating tank 112-1 in fluid communication with the water source 14 and the heating tank 112-2. For example, it is contemplated that the bypass system 180 may include one three-way valve that replaces the first and third valves 182, 186.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it is not intended that the invention be limited thereto, and it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments.

1. A water heating system for controlling the heating of potable water, the system comprising:
a tank for storing potable water, said tank in fluid communication with a source of potable water;
a refrigeration unit including a first fluid loop for circulating refrigerant, a compressor coupled to said first fluid loop for compressing refrigerant circulating in said first fluid loop, and a cooling fan that removes heat from refrigerant circulating in said first fluid loop;
a heat recovery unit having a first heat exchanger and a second fluid loop, the second fluid loop for circulating a first heat transfer medium between said tank and said first heat exchanger, said first heat exchanger including a first flow path which is part of said first fluid loop of said refrigeration unit, and a second flow path which is part of said second fluid loop and thermally coupled to said first flow path, said first flow path of said first heat exchanger disposed within said first fluid loop downstream from said compressor and upstream from said cooling fan; and
a solar water heater unit including a solar collector and a third fluid loop, the solar collector for extracting energy from insulation and heating a second heat transfer medium, the third fluid loop for circulating the second heat transfer medium between said tank and said solar collector.

2. (canceled)

3. The system of claim 1, further comprising:
fan control means for controlling operation of said cooling fan of said refrigeration unit, said fan control means including measuring means for measuring a property of the refrigerant circulating in said first fluid loop, said fan control means adapted to selectively activate and deactivate said cooling fan based upon the property of the refrigerant measured by the measuring means, said fan control means adapted to activate said cooling fan when the property of the refrigerant measured by the measuring means is higher than a predetermined threshold Th1_{FL1} and to deactivate said cooling fan when the property of the refrigerant measured by the measuring means is lower than the predetermined threshold Th1_{FL1}.

4-5. (canceled)

6. The system of claim 3, wherein:
the measured property of the refrigerant is one of temperature and pressure.

7. The system of claim 1, wherein:
said heat recovery unit includes a first circulating pump coupled to said second fluid loop for circulating said first heat transfer medium through said second fluid loop.

8. The system of claim 7, further comprising:
HRU control means for controlling operation of said first circulating pump of said heat recovery unit, said HRU control means including first measuring means for measuring a property of the refrigerant circulating in said first fluid loop and second measuring means for measuring a property of the potable water in said tank, said HRU control means adapted to selectively activate and deactivate said first circulating pump based upon the property of the refrigerant measured by said first measuring means and the property of the potable water in said tank measured by said second measuring means,
wherein, said HRU control means is adapted to activate said first circulating pump when the property of the water measured by said second measuring means is below a predetermined threshold Th1_{FL2}.

9-10. (canceled)

11. The system of claim 8, wherein:
said HRU control means activates said first circulating pump when the property of the refrigerant measured by said first measuring means exceeds a predetermined threshold ThMin_{Ref} and the property of the potable water in said tank measured by said second measuring means is less than a predetermined threshold ThMax_{Tank}, and
said HRU control means deactivates said first circulating pump when the property of the potable water in said tank measured by said second measuring means exceeds said predetermined threshold ThMax_{Tank}.

12. (canceled)

13. The system of claim 1, wherein:
said second fluid loop is in fluid communication with the water stored in said tank, and said first heat transfer medium comprises the water stored in said tank.

14. The system of claim 1, wherein:
said second fluid loop is fluidly isolated from the water stored in said tank.

15. The system of claim 1, wherein:
said solar water heater unit includes a second circulating pump coupled to said third fluid loop for said circulating of said second heat transfer medium through said third fluid loop.

16. The system of claim 15, further comprising:
solar control means for controlling operation of said second circulating pump of said solar water heater unit, said solar control means including first measuring means for measuring a property of the second heat transferring medium in said third fluid loop at said solar collector and second measuring means for measuring a property of the potable water in said tank, said solar control means adapted to selectively activate and deactivate said second circulating pump based upon the property of the second heat transferring medium measured by said first measuring means and the property of the potable water in said tank measured by said second measuring means,
wherein said solar control means is adapted to activate said second circulating pump when a difference calculated from the measured property of the second heat
transferring medium at said solar collector and the measured property of the potable water in said tank exceeds a predetermined value, and to deactivate said second circulating pump when the difference is less than said predetermined value.

17. (canceled)

18. The system of claim 16, wherein:
said solar control means includes a relief valve configurable to an open configuration for releasing some of the second heat transferring medium from said third fluid loop to lower the pressure within said third fluid loop when the measured property of the second heat transferring medium at said solar collector is less than a predetermined threshold ThMax_{Collector}.

19. The system of claim 16, wherein:
the difference exceeding said predetermined value indicates that said solar water heater unit may be used to heat the potable water in said tank, and
the difference less than said predetermined value indicates that said solar water heater unit would not sufficiently heat the potable water.

20. (canceled)

21. The system of claim 1, wherein:
said third fluid loop of said solar water heater unit is in fluid communication with the water stored in said tank, and said second heat transferring medium comprises the water stored in said tank.

22. The system of claim 1, wherein:
said third fluid loop of said solar water heater unit is fluidly isolated from the water stored in said tank.

23. The system of claim 1, wherein:
said solar water heater unit includes a second heat exchanger thermally coupled to said tank, and said third fluid loop circulates said second heat transferring medium from said tank to said solar collector, back to said tank, and through said second heat exchanger at said tank.

24. (canceled)

25. The system of claim 1, further comprising:
a second tank for storing potable water, said second tank in fluid communication with said first tank and the source of potable water.

26. (canceled)

27. In a water heating system for controlling the heating of potable water, the system including a tank for storing potable water and a refrigeration unit, said tank in fluid communication with a source of potable water, and said refrigeration unit including a first fluid loop for circulating refrigerant, a compressor coupled to said first fluid loop for compressing the refrigerant circulating in said first fluid loop, and a cooling fan that removes heat from the refrigerant circulating in said first fluid loop, an apparatus comprising:
a heat recovery unit having a first heat exchanger and a second fluid loop, the second fluid loop for circulating a first heat transfer medium between said tank and said first heat exchanger, said first heat exchanger including a first flow path which is part of said first fluid loop of said refrigeration unit, and a second flow path which is part of said second fluid loop and thermally coupled to said first flow path, wherein said first flow path of said first heat exchanger is disposed within said first fluid loop downstream from said compressor and upstream from said cooling fan; and
fan control means for controlling operation of said cooling fan of said refrigeration unit, said fan control means including measuring means for measuring a property of the refrigerant circulating in said first fluid loop, said fan control means adapted to selectively activate and deactivate said cooling fan based upon the property of the refrigerant measured by the measuring means.

28-30. (canceled)

31. The apparatus of claim 27, wherein:
said heat recovery unit includes a first circulating pump coupled to said second fluid loop for circulating said first heat transfer medium through said second fluid loop.

32. The apparatus of claim 27, further comprising:
HRU control means for controlling operation of said first circulating pump of said heat recovery unit, said HRU control means including first measuring means for measuring a property of the refrigerant circulating in said first fluid loop and second measuring means for measuring a property of the potable water in said tank, said HRU control means adapted to selectively activate and deactivate said first circulating pump based upon the property of the refrigerant measured by said first measuring means and the property of the potable water in said tank measured by said second measuring means
wherein, said HRU control means is adapted to activate said first circulating pump when the property of the water measured by said second measuring means is below a predetermined threshold Th1_{FL2}.

33-34. (canceled)

35. The apparatus of claim 32, wherein:
said HRU control means activates said first circulating pump when the property of the refrigerant measured by said first measuring means exceeds a predetermined threshold Th2_{FL1} and the property of the potable water in said tank measured by said second measuring means is less than a predetermined threshold ThMax_{Tank}, and
said HRU control means deactivates said first circulating pump when the property of the potable water in said tank measured by said second measuring means exceeds said predetermined threshold ThMax_{Tank}.

36-38. (canceled)
